(19) United States
(12) Patent Application Publication
(10) Pub. No.: US 2001/0003455 A1
(43) Pub. Date: Jun. 14, 2001

(54) Method, system and graphic user interface for entering and editing filter conditions for filtering a database

(76) Inventor: Dirk Grobler, Neumunster (DE)

Correspondence Address: Forrest Gunnison, Gunnison, McKay & Hodgson, L.L.P., 1900 Garden Road, Suite 220, Monterey, CA, 93940, US

(21) Appl. No.: 09/728,781

(22) Filed: Nov. 30, 2000

(30) Foreign Application Priority Data
Dec. 14, 1999 (EP) 99124940.0

(51) Int. Cl. G06F 17/00

(52) U.S. Cl. 345/418

(57) ABSTRACT

A method provides a tool, which enables a user to review or examine filter conditions set based on input forms in an easier manner. The method generates a filter condition tree view for display to the user. The tree view represents the filter conditions as set by the user in one or more input forms. The tree view is a particularly simple and efficient way of displaying the filter conditions set by the user, thereby making it easier for the user to check at a glance which conditions actually have been set. The user can not only set filter conditions to be linked by a Boolean AND, which are the filter conditions input into a single input form, but also the user can input filter conditions to be linked to other filter conditions by a Boolean function, e.g., a Boolean OR. This is attained by providing the user with multiple input forms, where the filter conditions set in one of the forms are linked to the filter conditions input in another of the forms by a Boolean OR.

### BACKGROUND OF THE INVENTION

1. Field of the Invention

The present invention relates generally to the filtering of databases, and more particularly, to the definition of form-based filter conditions for accessing the datasets of a database.

2. Description of Related Art

Database applications form a common tool used on computers. Database application programs are used to store and manage data. Database application programs also provide methods to retrieve and update the stored data.

The stored data forms the actual database where—in case of relational databases—datasets are stored as parts of tables arranged in columns and rows. The database application program that accesses the stored data is called a database management system (DBMS) and sometimes the combination of the DBMS and the stored data together in a somewhat vague terminology are referred to as a database.

Databases can be searched or queried by a query language, such as the structured query language (SQL), but it is also known to query a database based on input forms where filter conditions can be set for the individual fields of the datasets contained in the database.

The user interface for handling such form-based database filters up to now was not very convenient since the filter conditions set by the user were displayed by displaying the input forms. Displaying each input form in turn made it difficult for the user to quickly review or examine the set filter conditions.

### SUMMARY OF THE INVENTION

A method of this invention provides a tool, which enables a user to review or examine filter conditions set based on input forms in a manner more convenient to the user. According to one embodiment of the present invention, the method generates a tree view for display to the user. The tree view represents the filter conditions as set by the user in one or more input forms. The tree view is a particularly simple and efficient way of displaying the filter conditions set by the user, thereby making it easier for the user to check, at a glance, which conditions actually have been set.

The user can not only set filter conditions to be linked by a Boolean AND, which are the filter conditions input into a single input form, but also the user can input filter conditions to be linked to other filter conditions by a Boolean OR. This is attained by providing the user with multiple input forms, the filter conditions set in one of the forms are linked to the filter conditions input in another of the forms by a Boolean OR.

Thus, the method of this invention provides a visual representation of filter conditions for a database filter. The method receives filter conditions from a user completed input form, and then generates a tree view of the filter conditions for display. In one embodiment, this tree view includes a new node for additional filter conditions.

The method also includes receiving an edit to the filter conditions from the displayed tree view. The edit received includes receiving a user selection of the new node as the edit. In this case, the method generates a filter condition input form for the new node in response to receiving the user selection of the new node. The method links filter conditions from the filter condition input form to the filter conditions in the view tree by a Boolean OR.

In another embodiment, in response to receiving an edit to the filter conditions from the tree view, the method generates a context menu to allow the user to manipulate at least one entry in the tree view.

In the tree view, nodes of the tree view are to be linked by a Boolean OR, and leaves belonging to a node of the tree view are linked by a Boolean AND when filtering the data of the database. This provides a systematic display of the filter conditions set by the user, which can easily and quickly be reviewed and examined by the user. The filter conditions represented by the tree view also are stored to be available for later usage.

Another embodiment of the present invention includes a computer program product comprising computer program code for a method enabling a user to define the filter conditions for accessing a database based on an input form, the form containing fields where a user can set the filter conditions for one or more fields of the datasets stored in the database. The method comprises:

receiving filter conditions from a user completed input form; and

generating a tree view of the filter conditions for display.

### BRIEF DESCRIPTION OF THE DRAWINGS

FIG. 1 shows a block diagram of a computer system, which is used in connection with an embodiment of the present invention.

FIG. 2 illustrates a table stored in a database.

FIG. 3 shows an input form according to one embodiment of the present invention.

FIG. 4 shows a filter condition tree view according to an embodiment of the present invention.

FIG. 5 shows a screen display with the filter condition tree view of FIG. 4, and a new filter condition input form generated in response to the user selecting the new node in the filter condition tree view according to an embodiment of the present invention.

FIG. 6 shows another tree view, according to one embodiment of the present invention, after the filter condition from the input form of FIG. 5 is received.

FIG. 7 is a process flow diagram of a method according to one embodiment of the present invention.

In the drawings and the following detailed description, elements with the same reference numeral are the same element. Also, the first digit of a reference numeral for an element indicates the first drawing in which that element appeared.

### DETAILED DESCRIPTION

With a method 130 of the present invention, a user of a personal computer enters a complex database query containing complex filter conditions using one or more database filter input forms. Prior to submitting the complex database query for processing by a database management system (DBMS) 135, method 130 generates a filter condition tree view 190, sometimes called tree view 190, on a display screen 195 of monitor 116 for the user.

As explained more completely below, tree view 190 presents to the user the complex filter conditions input by the user. Tree view 190 is a particularly simple and efficient way of displaying these filter conditions. Tree view 190 makes it easier for the user to check, at a glance, which filter conditions actually have been set.

In one embodiment, via method 130, the user can not only input filter conditions to be linked by a Boolean AND, which are input using a single filter condition input form, but also the user can input filter conditions to be linked to other filter conditions by a Boolean OR. This is attained by providing the user with multiple filter condition input forms, the filter conditions set in one of the input forms being linked to the ones set in another input form by a Boolean OR while the filter conditions set within a single input form are linked by a Boolean AND. Herein, when it is said that elements in the tree view are linked by a Boolean function, it means that the recited elements in the tree view are to be linked by the Boolean function when filtering the data of the database.

Hence, method 130 of this invention eliminates the need for the user to page through several input forms to view the filter conditions. In addition, the Boolean AND and OR operations are presented in an intuitive manner that makes it easier for the user to visualize the query being submitted to database management system 135.

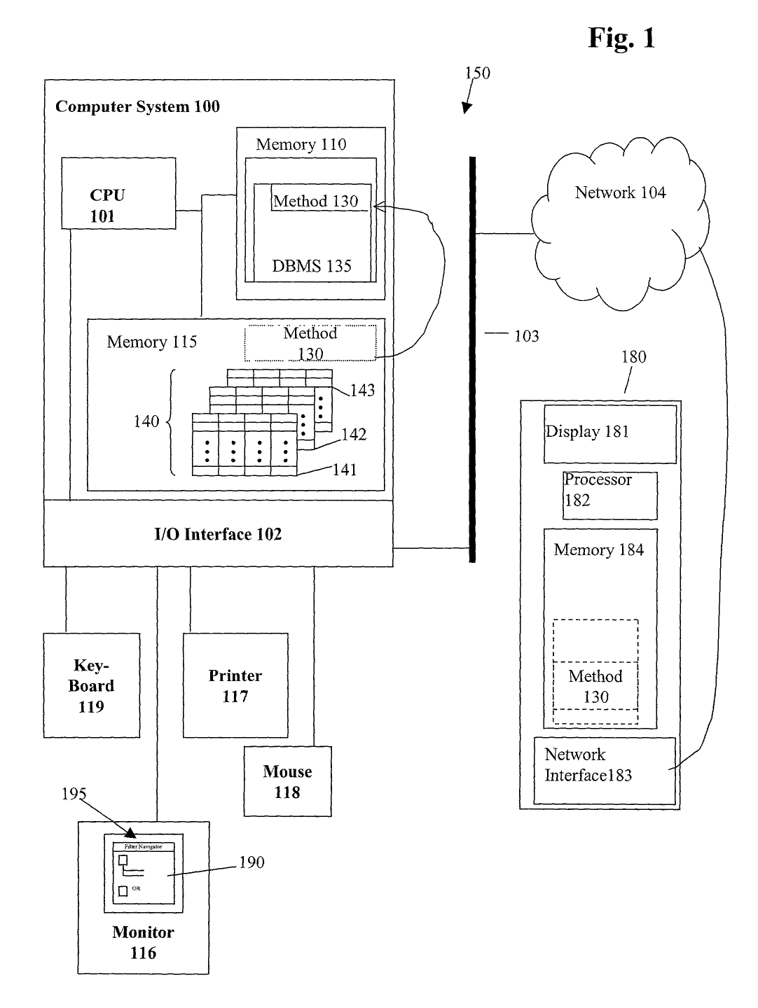

As illustrated in FIG. 1, database 140, in memory 115, contains tables 141 to 143 in which datasets of database 140 are stored and arranged in columns and rows. Database management system 135 including method 130 of this invention is a tool for accessing, editing, storing, and querying database tables 141 to 143. The results of an access, a query, or the like, typically are displayed on monitor 116 for viewing by the user.

In the embodiment of FIG. 1, DBMS 135 contains a tool, i.e., method 130, to perform a filtered access to database tables 141 to 143. This means that a user can set filter conditions via an input form, submit the input form so that database tables 141 to 143 are accessed and checked to determine whether the data contained therein matches the filter conditions. If a match is found, DBMS 135 displays on display screen 195 of monitor 116 only the datasets, which match the filter conditions. This sequence of operations is referred to herein as a filtering of a database.

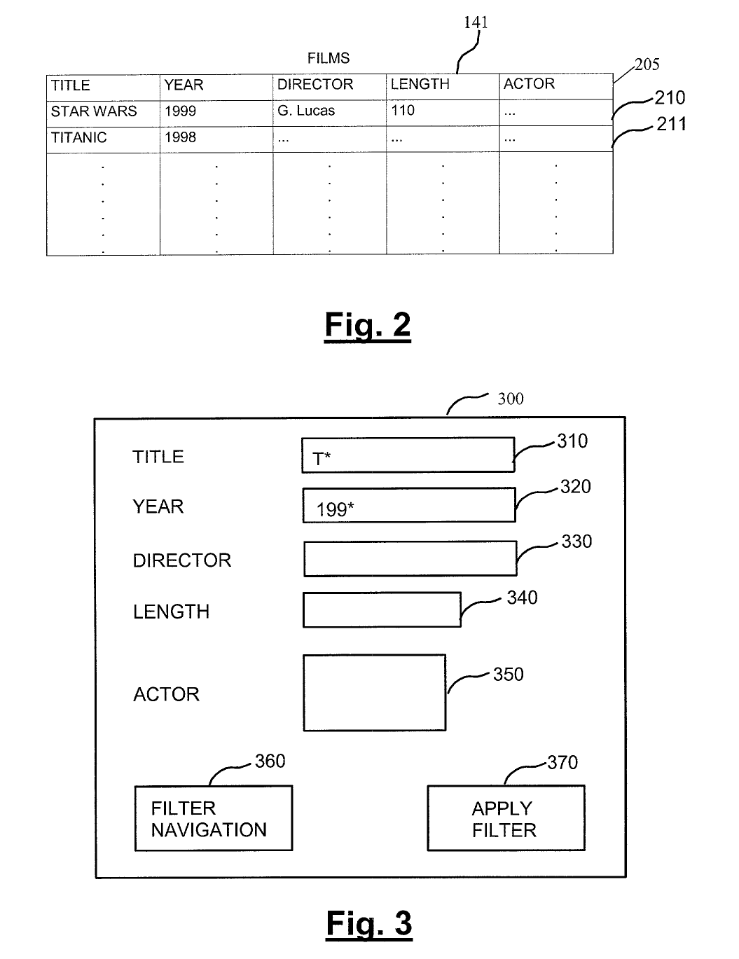

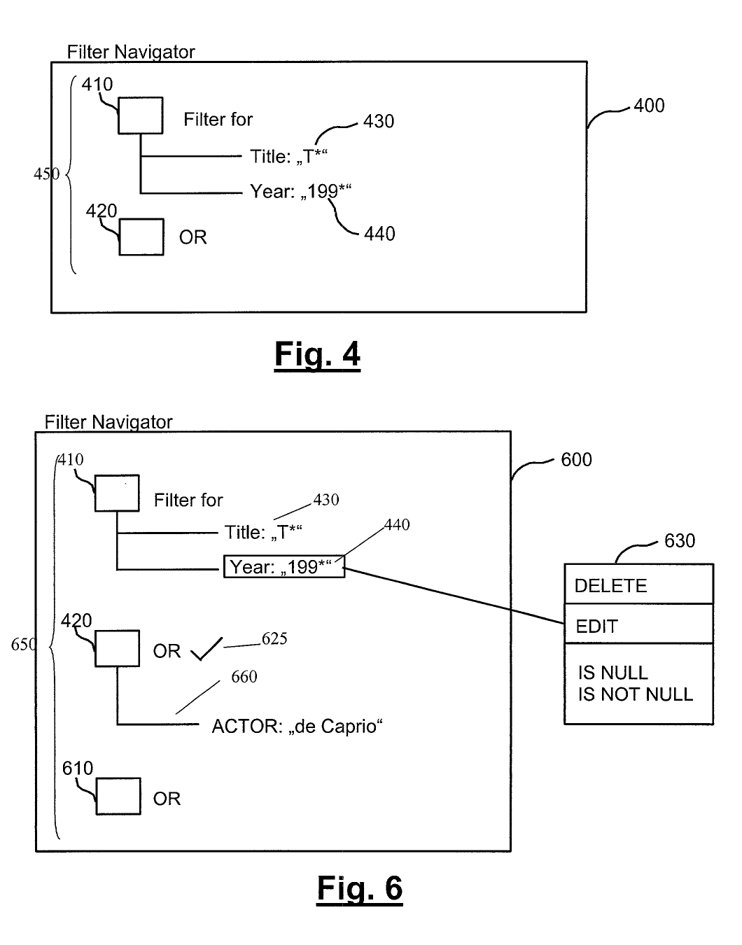

FIG. 2 is a more detailed example of database table 141 that is stored in database 140. Table 141 is part of a database 140 that is named “films”. The data in table 141 is arranged in columns and rows. First row 205 contains the descriptors for the individual columns, and following rows 210, 211, etc. form individual datasets contained in database 140. In this example, each dataset contains information about a film, such as the title of the film, the year of its production, its director and so on.

A user filters the contents of database 140 for retrieving only those datasets, which match filter conditions as defined by the user. In this embodiment, DBMS 135 generates a database filter condition input form 300, sometimes called input form 300, for display on display screen 195. Input form 300 contains individual fields 310, 320, 330, 340, and 350 in which the user can define filter conditions for the individual fields of the datasets of database 140, i.e., set the filter conditions.

A filter condition can be entered in a field of input form 300 either by inserting a complete term, or by inserting a partial term and a wildcard, e.g., the asterisks shown in fields 310 and 320 of form 300. Leaving a field empty, as in fields 330, 340 and 350, means that no filter condition is set for this field. In another embodiment, an icon is provided in a field and upon selection of the icon, the user is presented with a list box of items that can be selected for entry in that field.

In the example of FIG. 3, the user has chosen to extract or to filter all datasets from database 140 where the title of the film starts with the character “T” and where the production year lies in the range between 1990 and 1999. If the user selects button apply filter 370 of input form 300, method 130 applies the filter conditions specified in form 300 to database 140, and as a result the datasets matching the filter conditions are output, for example, to monitor 116, printer 117, both of these devices, or to a file on a storage device in computer system 150.

If the user selects button filter navigation 360, method 130 of this invention generates a filter navigator window 400 for display on monitor 116. Button 360 is illustrative of a filter navigation icon, which can be selected by a user, and is not intended to limit the invention to either the specific button icon, or to an icon. Filter navigator window 400 could also be generated, for example, in response to selection of a menu item from a tool bar, or to selection of an item in a list box by the user.

Filter navigator window 400 displays a filter condition tree view 450 of the filter conditions defined by the user in form 300(FIG. 3). In this example, tree view 450 in filter navigator window 400 contains nodes 410 and 420 as well as leaves 430 and 440 of node 410. Specifically, under node 410, there are displayed the filter conditions input in form 300 as leaves 430 and 440. In node 410, leaves 430 and 440 are linked by a Boolean AND.

Node 420 in filter navigation window 400 does not contain any leaves at this time and represents a new node. The “OR” next to node 420 indicates that a Boolean OR links nodes 410 and 420. The “OR” is an icon representing the Boolean function linking the nodes.

The use of a Boolean OR to link nodes 410 and 420 is illustrative only of a Boolean function, and is not intended to limit the invention to this specific function. In another embodiment, a button is provided next to the “OR” and upon selection of the button a list box associated with node 420 is displayed. The list box includes a list of Boolean functions. The user can select any Boolean function in the list and the user selected Boolean function is used to link nodes 410 and 420. An icon representing the selected Boolean function is displayed adjacent to node 420 in place of the default Boolean “OR” icon. Hence, in this embodiment, the Boolean OR is a default Boolean function that can be replaced by a user selected Boolean function.

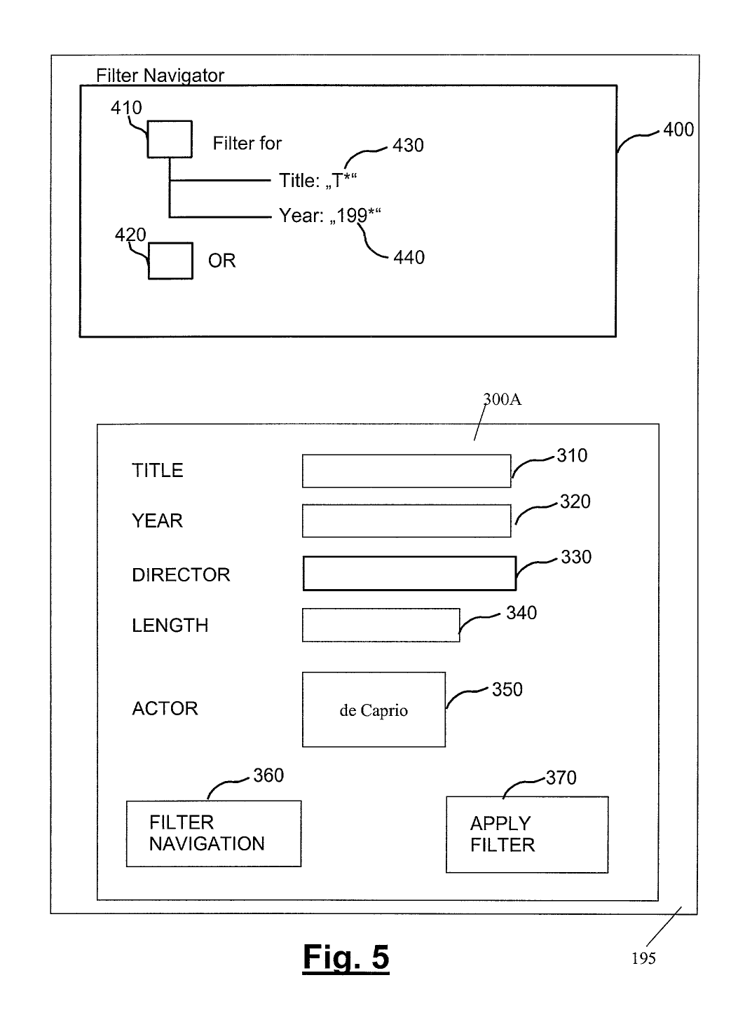

If the user selects node 420, the user is provided with a new (empty) input form 300A (FIG. 5) in which the user can input further filter conditions. In this embodiment, the user selects node 420 using mouse 118 and a screen cursor, keyboard 119, or perhaps a voice recognition system included in computer system 100.

In the example of FIG. 5, the user inputs “de Caprio” in actor field 350 of input form 300A. If the user again selects button file navigation 360 in input form 300A, the newly input filter conditions are automatically displayed in a new file navigator window 600.

Tree view 650 in file navigator window 600 includes the additional filter condition that an actor of the film should have the name “de Caprio”. Since this filter condition was input by the user in form 300A that was generated in response to the user selecting node 420, the new filter condition is a leaf 660 of node 420.

Check mark 625 next to the “OR” of node 420 indicates that node 420 is active. In other words, check mark 625 indicates that the filter condition shown as leaf 660 of node 420 is linked to the filter conditions of node 410 by a Boolean OR. A check mark is not shown next to the OR of node 610, which is now the new node in tree view 650. Check mark 625 is an example of additional node active icon, and is not intended to limit the invention to this specific icon. Any desired icon can be used as the additional node active icon so long as the icon provides a clear indication of whether the node is active.

Node 610 can be used for inputting further filter conditions that will be linked by an additional Boolean OR to nodes 410 and 420. By selecting node 610, the user would be provided with yet another input form, and the filter conditions input into this form would then be displayed as leaves belonging to node 610. Moreover, after having input those additional filter conditions, node 610 also would be marked by a check mark and a new input node would added to the tree view.

Hence, any filter conditions input in a single form are linked by a Boolean AND, and filter conditions input in different input forms are linked by a Boolean OR as illustrated in tree view 650 of FIG. 6. In addition to adding new nodes that are linked by a Boolean OR to other nodes in tree view 650, the user can edit a node, a leaf, or both in tree view 650.

When looking at filter navigator window 600, the user readily recognizes that the so far defined filter conditions define a search for films the title of which starts with a “T” and the production year of which lies in the 90's, or for films where the actor is “de Caprio”. The user can edit the filter conditions using filter navigator window 600 in a number of ways.

For example, if the user selected node 410 in tree view 650, the user would again be presented with input form 300 (FIG. 3). The user could enter additional filter conditions in form 300 that would be displayed as additional leaves for node 410 in window 600.

Alternatively, the filter conditions, as displayed in window 600, can be modified by the user through drag-and-drop operations that move a filter condition from one node to another node.

A specific leaf in tree view 650 can be edited by the user selecting the leaf, e.g., leaf 440, and calling a context menu. Window 630 is a context menu for the selected leaf 440, which is a filter condition production year. The user can choose in the context menu whether the user wishes to delete or to edit the filter condition for production year, whether the filter condition for production year should be set as null, or whether the filter condition for production year should be set as not being null.

To set a filter condition to null means that only those datasets are retrieved where the corresponding data field of the dataset contains no entry. The option “is not null” means that only datasets are retrieved, which, in this field, have an entry.

Hence, tree view 650 provides the user with a highly convenient and easy way to manage a view onto the defined filter conditions. The user can review or examine at a glance which filter conditions have been set, and can very easily modify the filter conditions.

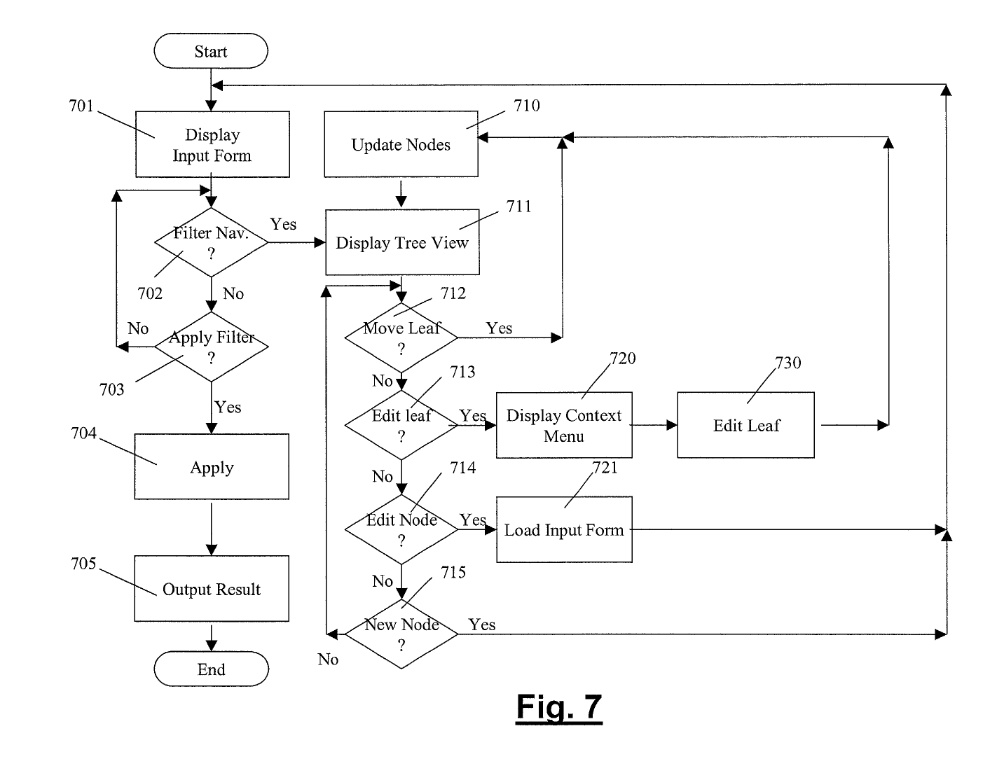

FIG. 7 shows a process flow diagram for one embodiment of method 130 of this invention. Initially, in display input form operation 701, DBMS 135 generates an input form 300 on screen display 195. As explained above, the user inputs filter conditions into form 300 using one or more of the input devices of computer system 100.

After the user inputs the desired filter conditions, the user can either apply the filter by clicking on button 370, or generate a filter navigation window by clicking on button 360. In either case, method 130 receives the filter conditions from the user completed input form.

Filter navigation check operation 702 determines whether the user clicked on button 360, and if the user did, transfers processing to display tree view operation 711. Similarly, apply filter check operation 703 determines whether the user clicked on button 370 and if the user did, transfers processing to apply filter operation 704.

In display tree view operation 711, method 130 generates a filter navigator window that includes a tree view that in turn corresponds to the filter condition or conditions input by the user. In addition, a new node is added to the tree view, as described above.

In the filter navigator window, the user can choose whether to modify the filter conditions displayed in the tree view. In the embodiment of FIG. 7, the user can move a leaf, edit a leaf, edit a node, or add filter conditions to the new node in the displayed tree view.

Move leaf check operation 712 determines whether the user has used a drag and drop operation to modify the filter conditions. If the user has used the drag and drop operation, check operation 712 transfers to update nodes operation 710. Update nodes operation 710 saves the new filter conditions for each node in the tree view, and updates the tree view display accordingly. Operation 710 transfers to display tree view operation 711 that in turn displays the new tree view after the user's edit.

Edit leaf check operation 713 determines whether the user selected a leaf in the tree view and then called the context menu. If the user performed such an operation, check operation 713 transfers to display context menu operation 720 that in turn generates the context menu window for display. Operation 720 transfers to edit leaf operation 730, in which the user performs one of the operations permitted by the context menu, as described above. Edit leaf operation 730 transfers to update nodes operation 710 that performs as described above.

Edit node check operation 714 determines whether the user selected a node in the tree view that already had filter conditions set. If the user selected such a node, check operation 714 transfers to load input form operation 721. Operation 721 loads the set filter conditions for the selected node in the input form and transfers to display input form operation 701. Operation 701 displays the input form with the loaded filter conditions previously input by the user. The user can edit the filter conditions at this time.

New node check operation 715 determines whether the user selected the new node in the displayed tree view. If the user selected the new node, processing transfers to display input form operation 701 so that the user can input the filter conditions for the new node.

When the user has completed inputting the filter conditions and is satisfied that the filter conditions, as displayed in the tree view are correct, the user clicks on button 370 and apply filter check operation 703 transfers to apply filter operation 704.

The filter, as defined by the filter conditions in the tree view, is then applied to the contents of the database in operations 704 and the results, which match the filter conditions, are defined as output. Output result operation 705 presents the output in accordance with the instructions provided by the user to DBMS 135.

Those skilled in the art will readily recognize that the individual operations mentioned before in connection with the procedure of generating a database filter according to method 130 of the present invention (and other operations and functions mentioned in connection with the foregoing description of one embodiment of the invention) can be performed by executing computer program instructions on CPU 101 of computer 100. In another embodiment, all or part of method 130 may also be implemented by dedicated electronic circuits, which are configured such that they perform the individual operations explained before in connection with method 130 of the present invention. In yet another embodiment of the invention, a storage medium has installed thereon computer-executable program code for method 130. Execution of the computer-executable code causes the CPU of a computer to perform the operations explained for method 130.

In still another embodiment of the present invention, method 130 is executed on to a hardware configuration like a personal computer or workstation as illustrated schematically in FIG. 1 by computer system 100. Method 130, however, may also be applied to a client-server configuration 150 that also is illustrated in FIG. 1. The input forms and filter navigator and related windows may be displayed on a display screen of client device 100 while some or all operations of method 130 are carried out on a server computer 180 accessible by client device 100 over a data network 104, such as the Internet, using a browser application or the like.

Herein, a computer program product comprises a medium configured to store or transport computer readable code for method 130 or in which computer readable code for method 130 is stored. Some examples of computer program products are CD-ROM discs, ROM cards, floppy discs, magnetic tapes, computer hard drives, servers on a network and signals transmitted over a network representing computer readable program code.

As illustrated in FIG. 1, this storage medium may belong to computer system 100 itself. However, the storage medium also may be removed from computer system 100. For example, method 130 and DBMS 135 may be stored in memory 184 that is physically located in a location different from processor 101. The only requirement is that processor 101 is coupled to the memory containing method 130. This could be accomplished in a client-server system 150, e.g. system 100 is the client and system 180 is the server, or alternatively via a connection to another computer via modems and analog lines, or digital interfaces and a digital carrier line.

For example, memory 184 could be in a World Wide Web portal, while display unit 116 and processor 101 are in a personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 100, in one embodiment, can be a portable computer, a workstation, a two-way pager, a cellular telephone, a digital wireless telephone, a personal digital assistant, a server computer, an Internet appliance, or any other device that includes the components shown and that can execute method 130, or at least can provide the input instructions to method 130 that is executed on another system. Similarly, in another embodiment, computer system 100 can be comprised of multiple different computers, wireless devices, cellular telephones, digital telephones, two-way pagers, or personal digital assistants, server computers, or any desired combination of these devices that are interconnected to perform method 130 as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, method 130 can be implemented on a wide variety of computer system configurations. In addition, method 130 could be stored as different modules in memories of different devices. For example, method 130 could initially be stored in a server computer 180, and then as necessary, a module of method 130 could be transferred to a client device 100 and executed on client device 100. Consequently, part of method 130 would be executed on the server processor 182, and another part of method 130 would be executed on processor 101 of client device 100. In view of this disclosure, those of skill in the art can implement the invention of a wide variety of physical hardware configurations using an operating system and computer programming language of interest to the user. For example, FIG. 1 shows input devices 119 and 118, but other input devices, such as speech recognition software and/or hardware could be used to input the selections and data for method 130.

In yet another embodiment, method 130 is stored in memory 184 of system 180. Stored method 130 is transferred, over network 104 to memory 115 in system 100. In this embodiment, network interface 183 and I/O interface 102 would include analog modems, digital modems, or a network interface card. If modems are used, network 104 includes a communications network, and method 130 is downloaded via the communications network.

Method 130 of the present invention may be implemented in a computer program including a comprehensive STAROFFICE office application that is available from Sun Microsystems, Inc. of Palo Alto, Calif. (STAROFFICE is a trademark of Sun Microsystems.) Such a computer program may be stored on any common data carrier like, for example, a floppy disk or a compact disc (CD), as well as on any common computer system's storage facilities like hard disks. Therefore, another embodiment of the present invention also relates to a data carrier for storing a computer program for carrying out the inventive method. Still another embodiment of the present invention relates to a method for using a computer system for carrying out the presented inventive method.

While the present invention hereinbefore has been explained in connection with one embodiment thereof, those skilled in the art will readily recognize that modifications can be made to this embodiment without departing from the spirit and scope of the present invention.

I claim:

1. A method for providing a visual representation of filter conditions for a database filter, said method comprising:
receiving filter conditions from a user completed input form; and
generating a tree view of said filter conditions for display.

2. The method of claim 1 further comprising:
including, in said tree view, a new node for additional filter conditions.

3. The method of claim 2, further comprising:
receiving an edit to said filter conditions from said tree view.

4. The method of claim 3, where said receiving an edit further comprises:
receiving a user selection of said new node as said edit.

5. The method of claim 4 wherein said method further comprises:
generating a filter condition input form for said new node in response to receiving said user selection of said new node.

6. The method of claim 5 further comprising:
linking filter conditions from said filter condition input form to said filter conditions by a Boolean function.

7. The method of claim 1, further comprising:
receiving an edit to said filter conditions from said tree view.

8. The method of claim 7 wherein in response to receiving said edit, said method further comprises:
generating a context menu to manipulate at least one entry in said tree view.

9. The method of claim 1, wherein the filter conditions from a single input form are linked by a Boolean AND.

10. The method of claim 1, wherein
nodes of said tree view are to be linked by a Boolean OR; and
leaves belonging to a node of said tree view are linked by a Boolean AND when filtering the data of said database.

11. A computer program product comprising computer program code for a method enabling a user to define the filter conditions for accessing a database based on an input form, said form containing fields where a user can set the filter conditions for one or more fields of the datasets stored in said database, said method comprising:
receiving filter conditions from a user completed input form; and
generating a tree view of said filter conditions for display.

12. The computer program product of claim 11, said method further comprising:
including, in said tree view, a new node for additional filter conditions.

13. The computer program product of claim 12, said method further comprising:
receiving an edit to said filter conditions from said tree view.

14. The computer program product of claim 13, where said receiving an edit further comprises:
receiving a user selection of said new node as said edit.

15. The computer program product of claim 14 wherein said method further comprises:
generating a filter condition input form for said new node in response to receiving said user selection of said new node.

16. The computer program product of claim 15 said method further comprising:
linking filter conditions from said filter condition input form to said filter conditions by a Boolean function.

17. The computer program product of claim 11, said method further comprising:
receiving an edit to said filter conditions from said tree view.

18. The computer program product of claim 17 wherein in response to receiving said edit, said method further comprises:
generating a context menu to manipulate at least one entry in said tree view.

19. The computer program product of claim 11, wherein the filter conditions from a single input form are linked by a Boolean AND.

20. The computer program product of claim 11, wherein
nodes of said tree view are to be linked by a Boolean OR; and
leaves belonging to a node of said tree view are linked by a Boolean AND when filtering the data of said database.

21. A system comprising:
a processor;
a memory coupled to said processor, and having stored therein instructions for a method for providing a visual representation of filter conditions for a database filter wherein upon execution of said instructions on said processor, said method comprises:
receiving filter conditions from a user completed input form; and
generating a tree view of said filter conditions for display.

22. A graphic user interface comprising:
a database filter condition form input window comprising:
at least one filter condition input field; and
a filter navigation icon; and
a filter navigation window displayed upon selection of said filter navigation icon in said database filter condition form input window, wherein said filter navigation window includes a filter condition tree view including a filter condition from said at least one filter condition input field.
